(19) United States
(12) Patent Application Publication
(10) Pub. No.: US 2024/0282048 A1
(43) Pub. Date: Aug. 22, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Kiyoshi IIDA, Kanagawa (JP); Hirotake SASAKI, Kanagawa (JP); Toshihiko SUZUKI, Kanagawa (JP)

(73) Assignee: FUJIFILM Business Innovation Corp., Tokyo (JP)

(21) Appl. No.: 18/453,676

(22) Filed: Aug. 22, 2023

(30) Foreign Application Priority Data
Feb. 22, 2023 (JP) 2023-025902

(51) Int. Cl. G06T 15/20; G06T 17/10

(52) U.S. Cl. CPC G06T 15/20; G06T 17/10

(57) ABSTRACT

An information processing system includes a processor configured to: display a three-dimensional model representing an object, following a position of an information processing apparatus that photographs the object, on a display for a supporter who supports an operation by an operator who uses the information processing apparatus; and when a specific operation is performed for the three-dimensional model displayed on the display, display the three-dimensional model on the display in such a manner that an orientation of the three-dimensional model is fixed.

### CROSS-REFERENCE TO RELATED APPLICATIONS

This application is based on and claims priority under 35 USC 119 from Japanese Patent Application No. 2023-025902 filed Feb. 22, 2023.

### BACKGROUND

### (i) Technical Field

The present disclosure relates to an information processing system, a non-transitory computer readable medium, and an information processing method.

### (ii) Related Art

A system that displays an image captured by an operator apparatus, which is an example of an information processing apparatus, on a display for a supporter who supports an operation by an operator who uses the operator apparatus has been known. For example, the supporter may remotely support an operation by the operator.

In Japanese Unexamined Patent Application Publication No. 2006-209664, a method for acquiring a stereo image of a first stereo imaging unit worn by a first user, acquiring a second stereo image based on a stereo image of a second stereo imaging unit installed in a space where the first user is present and a virtual object image of the second stereo imaging unit, and presenting an image selected by a second user to the second user, is described.

In Japanese Unexamined Patent Application Publication No. 2017-58752, a method for generating a three-dimensional panorama image and displaying the three-dimensional panorama image on a first display unit, and outputting, in accordance with specification of an object on the three-dimensional panorama image, based on the current posture information on a camera, positional information on the specified object to a second display unit, is described.

In Japanese Unexamined Patent Application Publication No. 2006-293604, a system that generates an image of a virtual space that reflects operation results by first operation means used by a first observer to operate a virtual object and second operation means used by a second observer who remotely supports an operation on the virtual object by the first observer to operate the virtual object, is described.

### SUMMARY

In the case where a supporter supports an operation by an operator, an image captured by an operator apparatus that the operator uses may be displayed on a display for the supporter, and the supporter may reference the image to support the operator. In the case where an image captured by the operator apparatus is directly displayed on the display, the supporter provides support with reference to a range photographed by the operator apparatus (for example, the field of view of the operator). However, in this case, it is not necessarily easy to provide such support.

Aspects of non-limiting embodiments of the present disclosure relate to allowing a supporter to easily support an operation by an operator who uses an information processing apparatus, compared to a case where an image captured by the information processing apparatus is directly displayed on a display for the supporter.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: display a three-dimensional model representing an object, following a position of an information processing apparatus that photographs the object, on a display for a supporter who supports an operation by an operator who uses the information processing apparatus; and when a specific operation is performed for the three-dimensional model displayed on the display, display the three-dimensional model on the display in such a manner that an orientation of the three-dimensional model is fixed.

### BRIEF DESCRIPTION OF THE DRAWINGS

Exemplary embodiments of the present disclosure will be described in detail based on the following figures, wherein:

FIG. 1 is a block diagram illustrating a configuration of an information processing system according to an exemplary embodiment;

FIG. 2 is a block diagram illustrating a configuration of an operator apparatus according to an exemplary embodiment;

FIG. 3 is a block diagram illustrating a configuration of a supporter apparatus according to an exemplary embodiment;

FIG. 4 is a diagram illustrating a field and a remote location;

FIG. 5 is a diagram illustrating the field and the remote location;

FIG. 6 is a flowchart illustrating the flow of a process performed by the operator apparatus;

FIG. 7 is a flowchart illustrating the flow of a process performed by the supporter apparatus;

FIG. 8 is a flowchart illustrating the flow of a process performed by the operator apparatus;

FIG. 9 is a flowchart illustrating the flow of a process performed by the supporter apparatus; and

FIG. 10 is a flowchart illustrating the flow of a process performed by the supporter apparatus.

### DETAILED DESCRIPTION

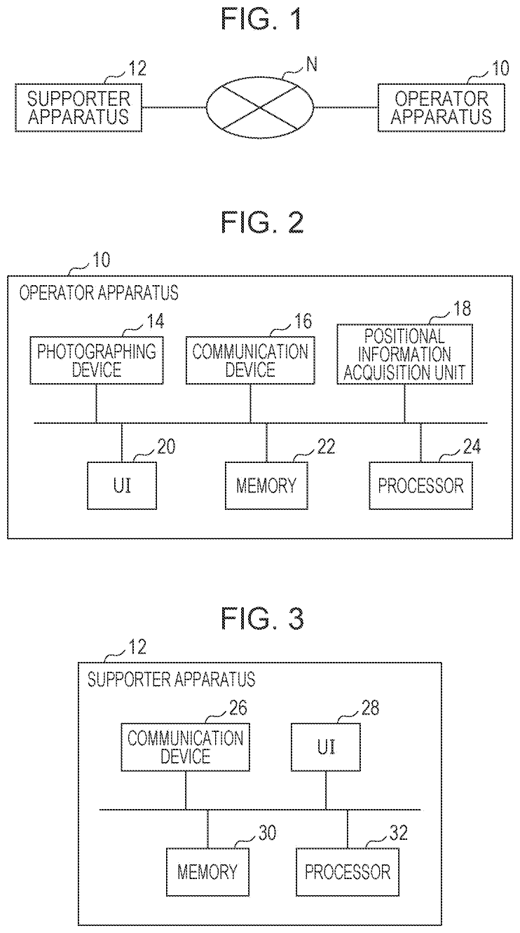

An information processing system according to an exemplary embodiment will be described with reference to FIG. 1. FIG. 1 is a block diagram illustrating an example of the configuration of an information processing system according to an exemplary embodiment.

The information processing system according to this exemplary embodiment includes an operator apparatus 10 and a supporter apparatus 12. The operator apparatus 10 and the supporter apparatus 12 each have a function for performing communication with an external apparatus. The communication may be wired communication or wireless communication. The wireless communication includes, for example, short-range wireless communication, Wi-Fi (registered trademark), and the like. Wireless communications other than the above standards may be used. For example, the operator apparatus 10 and the supporter apparatus 12 communicate with each other via a communication path N such as a local area network (LAN) or the Internet. The operator apparatus 10 and the supporter apparatus 12 may communicate with each other via an external apparatus such as a server.

Part of the functions of the operator apparatus 10 may be implemented by an external apparatus other than the operator apparatus 10. In this case, the operator apparatus 10 and the external apparatus may configurate an information processing system different from the above-mentioned information processing system, and all the functions of the operator apparatus 10 may be implemented by the information processing system.

Similarly, part of the functions of the supporter apparatus 12 may be implemented by an external apparatus other than the supporter apparatus 12. In this case, the supporter apparatus 12 and the external apparatus may configurate an information processing system different from the above-mentioned information processing system, and all the functions of the supporter apparatus 12 may be implemented by the information processing system.

The operator apparatus 10 is an apparatus used by an operator. For example, the operator apparatus 10 is an information processing apparatus having a photographing function, such as a head mount display (HMD) like smart glasses, a personal computer (PC), a tablet PC, a photographing apparatus like a camera or a video camera, a smartphone, or a mobile phone.

The supporter apparatus 12 is an apparatus used by a supporter who supports an operation by an operator. The supporter apparatus 12 is, for example, an HMD, a PC, a tablet PC, a smartphone, or a mobile phone.

For example, when an image (for example, a moving image or a still image) is captured by a camera of the operator apparatus 10, data of the image is transmitted from the operator apparatus 10 to the supporter apparatus 12 via the communication path N. The image is displayed on a display of the supporter apparatus 12. Furthermore, when sound such as voice is picked up by a microphone of the operator apparatus 10, data of the sound is transmitted from the operator apparatus 10 to the supporter apparatus 12 via the communication path N. The sound is output from a speaker of the supporter apparatus 12. The supporter references the image or listens to the sound and then provides an instruction to the operator.

For example, when the supporter operates the supporter apparatus 12 to provide an instruction to the operator, information indicating the instruction is transmitted to the operator apparatus 10 via the communication path N. The information indicating the instruction is output through the operator apparatus 10. For example, the information indicating the instruction is displayed on the display of the operator apparatus 10 or output as sound.

The supporter may support an operation by a single operator or support operations by a plurality of operators. For example, a plurality of operator apparatuses 10 may be included in the information processing system, and the supporter may provide instructions to the individual operators.

A hardware configuration of the operator apparatus 10 will be described below with reference to FIG. 2. FIG. 2 illustrates an example of the hardware configuration of the operator apparatus 10.

The operator apparatus 10 includes a photographing device 14, a communication device 16, a positional information acquisition unit 18, a user interface (UI) 20, a memory 22, and a processor 24.

The photographing device 14 is a camera and performs photographing to generate an image (for example, a moving image or a still image). For example, data of the image is transmitted to the supporter apparatus 12 via the communication path N.

The communication device 16 includes one or a plurality of communication interfaces each including a communication chip, a communication circuit, and the like and has a function for transmitting information to other apparatuses and a function for receiving information from other apparatuses. The communication device 16 may have a wireless communication function and may have a wired communication function.

The positional information acquisition unit 18 includes devices such as a global positioning system (GPS), an acceleration sensor, a gyroscope sensor, and a magnetic sensor and acquires positional information and posture information on the operator apparatus 10. The positional information is information indicating the position of the operator apparatus 10 in the real three-dimensional space. The posture information is information indicating the posture of the operator apparatus 10 (for example, the orientation and tilt of the operator apparatus 10) in the real three-dimensional space.

The UI 20 is a user interface and includes a display and an input device. The display is a liquid crystal display, an electroluminescence (EL) display, or the like. The input device includes a keyboard, a mouse, input keys, an operation panel, and the like. The UI 20 may be a UI such as a touch panel serving as both the display and the input device. The UI 20 also includes a microphone and a speaker.

The memory 22 is a device including one or a plurality of memory regions in which data are stored. The memory 22 is, for example, a hard disk drive (HDD), a solid state drive (SSD), a memory (for example, a random access memory (RAM), a dynamic random access memory (DRAM), a nonvolatile random access memory (NVRAM), a read only memory (ROM), or the like), other types of memory device (for example, an optical disc), or a combination of the above-mentioned devices.

The processor 24 controls operations of the units of the operator apparatus 10.

A hardware configuration of the supporter apparatus 12 will be described below with reference to FIG. 3. FIG. 3 illustrates an example of the hardware configuration of the supporter apparatus 12.

The supporter apparatus 12 includes a communication device 26, a user interface (UI) 28, a memory 30, and a processor 32.

The communication device 26 includes one or a plurality of communication interfaces each including a communication chip, a communication circuit, and the like and has a function for transmitting information to other apparatuses and a function for receiving information from other apparatuses. The communication device 26 may have a wireless communication function and may have a wired communication function.

The UI 28 is a user interface and includes a display and an input device. The display is a liquid crystal display, an EL display, or the like. The input device includes a keyboard, a mouse, input keys, an operation panel, and the like. The UI 28 may be a UI such as a touch panel serving as both the display and the input device. The UI 28 also includes a microphone and a speaker.

The memory 30 is a device including one or a plurality of memory regions in which data are stored. The memory 30 is, for example, an HDD, an SSD, a memory (for example, a RAM, a DRAM, an NVRAM, a ROM, or the like), other types of memory device (for example, an optical disc), or a combination of the above-mentioned devices.

The processor 32 controls operations of the units of the supporter apparatus 12.

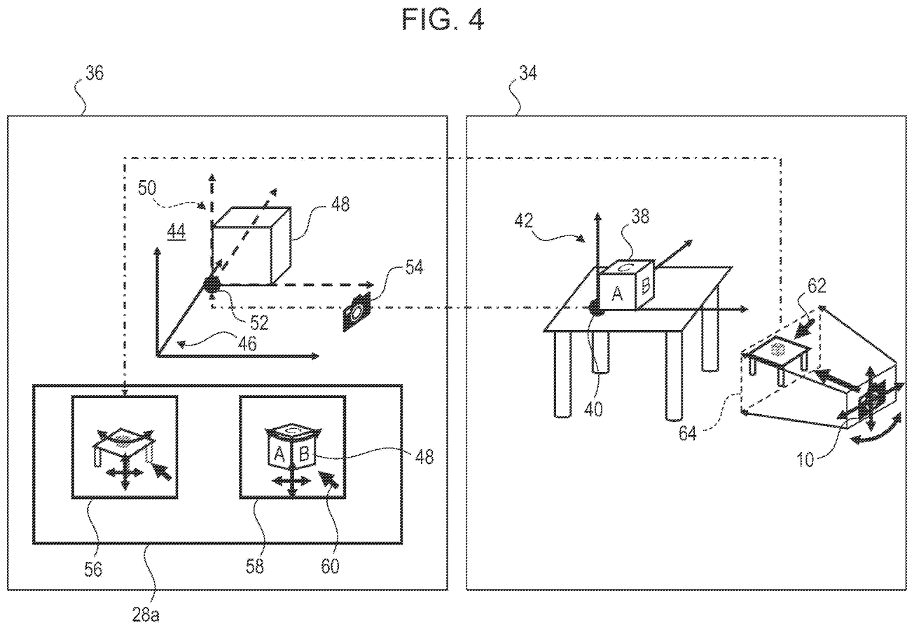

The information processing system according to an exemplary embodiment will be described in detail below with reference to FIG. 4. FIG. 4 illustrates a field 34 and a remote location 36.

The field 34 is a place where the operator performs an operation. In the example illustrated in FIG. 4, an operation object 38 is present in the field 34. In this example, the operator apparatus 10 is an HMD. The operator is wearing the operator apparatus 10 on the head and performs an operation in the field 34.

The remote location 36 is a place where the supporter supports an operation by the operator. The supporter apparatus 12 is installed at the remote location 36, and the supporter is present at the remote location 36 and supports an operation by the operator.

In the field 34, a three-dimensional orthogonal coordinate system 42 for tracking whose origin 40 is set at a predetermined position is set in advance. For example, a vertex or the like of the object 38 is defined as the origin 40. The three-dimensional orthogonal coordinate system 42 is a coordinate system defined in the real space.

A three-dimensional virtual space 44 is set on the supporter apparatus 12. A three-dimensional orthogonal coordinate system 46 is set in the three-dimensional virtual space 44. The three-dimensional orthogonal coordinate system 46 is a coordinate system defined in the virtual space. Data of a three-dimensional model 48 representing the object 38 is stored in advance in the memory 30 of the supporter apparatus 12. The three-dimensional model 48 is a virtual model present in the three-dimensional virtual space 44. A three-dimensional orthogonal coordinate system 50 corresponding to the three-dimensional orthogonal coordinate system 42 set in the field 34 is defined in the three-dimensional virtual space 44. An origin 52 of the three-dimensional orthogonal coordinate system 50 corresponds to the origin 40 of the three-dimensional orthogonal coordinate system 42. The three-dimensional orthogonal coordinate system 50 may be a coordinate system that matches the three-dimensional orthogonal coordinate system 46.

The positional information acquisition unit 18 of the operator apparatus 10 acquires positional information and posture information on the operator apparatus 10. The positional information is information indicating the position of the operator apparatus 10 in the real three-dimensional space and is defined by the three-dimensional orthogonal coordinate system 42 based on the origin 40. The posture information is information indicating the posture of the operator apparatus 10 (for example, the orientation and tilt of the operator apparatus 10) in the real three-dimensional space.

The processor 24 of the operator apparatus 10 transmits the positional information and the posture information on the operator apparatus 10 to the supporter apparatus 12. Furthermore, when an image is captured by the photographing device 14, the processor 24 of the operator apparatus 10 transmits data of the image to the supporter apparatus 12.

The processor 32 of the supporter apparatus 12 receives the positional information and the posture information on the operator apparatus 10 from the operator apparatus 10. The processor 32 arranges a virtual camera 54 representing the operator apparatus 10 with the posture indicated by the posture information at the position indicated by the positional information in the three-dimensional virtual space 44. When the position and the posture of the operator apparatus 10 change in the field 34, the position and the posture of the virtual camera 54 in the three-dimensional virtual space 44 also change. As described above, the position and the posture of the virtual camera 54 in the three-dimensional virtual space 44 changes, following the position and the posture of the operator apparatus 10. The processor 32 may make the posture of the virtual camera 54 match the posture of the operator apparatus 10 in the field 34 and place the virtual camera 54 at a position at which the entire three-dimensional model 48 is projected in the three-dimensional virtual space 44. The processor 32 may change the position of the virtual camera 54 in the three-dimensional virtual space 44 not following the posture of the operator apparatus 10 but following the position of the operator apparatus 10. That is, the processor 32 may place the virtual camera 54 at the position indicated by the positional information of the operator apparatus 10 in the three-dimensional virtual space 44. This also applies to an exemplary embodiment described below. In this case, the processor 32 may receive the posture information of the operator apparatus 10 from the operator apparatus 10 or does not necessarily receive the posture information. In the case where the processor 32 does not receive the posture information, for example, a predetermined orientation (for example, posture facing the origin 40) may be set in advance as the orientation of the virtual camera 54.

A screen 56 and a screen 58 are displayed on a display 28a of the UI 28 of the supporter apparatus 12.

The screen 56 is a screen on which an image of the field 34 is displayed. An image captured by the photographing device 14 of the operator apparatus 10 is displayed on the screen 56. When receiving data of the image captured by the photographing device 14 from the operator apparatus 10, the processor 32 of the supporter apparatus 12 displays the image on the screen 56. For example, in the case where the operator is wearing the HMD as the operator apparatus 10 on the head, an image representing the field of view of the operator is displayed on the screen 56.

The screen 58 is a screen on which the three-dimensional model 48 of the object 38 is displayed. The processor 32 of the supporter apparatus 12 displays, on the screen 58, a model arranged within the field of view from the position of the virtual camera 54 in the three-dimensional virtual space 44. That is, the processor 32 displays, on the screen 58, the three-dimensional model 48 seen from the virtual camera 54 representing the operator apparatus 10 in the three-dimensional virtual space 44. Since the position and the posture of the virtual camera 54 change following the motion of the operator apparatus 10, the processor 32 displays the three-dimensional model 48 on the screen 58 while making the position and the posture of the three-dimensional model 48 change following the motion of the operator apparatus 10. As described above, the processor 32 may change the position of the three-dimensional model 48 not following the posture of the operator apparatus 10 but following the position of the operator apparatus 10. In this case, a predetermined orientation (for example, posture facing the origin 40) may be set in advance as the orientation of the virtual camera 54.

The screen 58 is a screen used by the supporter to support an operation by the operator. The supporter provides an instruction to the operator on the screen 58. The supporter provides instructions regarding the position of the operator apparatus 10 at which the operator apparatus 10 is to photograph the object 38 in the field 34 and the posture of the operator apparatus 10 at the position. For example, the processor 32 of the supporter apparatus 12 displays, on the screen 58, an annotation 60 used by the supporter to provide an instruction. The annotation 60 is an image, a character string, or the like representing an instruction for the operator. In the example illustrated in FIG. 4, an image of an arrow representing the position and the posture of the operator apparatus 10 is used as the annotation 60. The supporter designates, on the screen 58, the position and the posture of the annotation 60 with respect to the three-dimensional model 48.

The position of the annotation 60 with respect to the three-dimensional model 48 is the position of the operator apparatus 10 at which the operator apparatus 10 is to photograph the object 38 in the field 34. The posture of the annotation 60 with respect to the three-dimensional model 48 is the posture of the operator apparatus 10 at the position at which the operator apparatus 10 is to photograph the object 38. The processor 32 of the supporter apparatus 12 transmits instruction information indicating the instruction to the operator apparatus 10. The instruction information includes positional information indicating the position of the operator apparatus 10 and posture information indicating the posture of the operator apparatus 10 at the position.

When receiving the instruction information transmitted from the supporter apparatus 12, the processor 24 of the operator apparatus 10 displays an annotation 62 on the display of the UI 20 of the operator apparatus 10. For example, the processor 24 displays, using augmented reality (AR) technology or mixed reality (MR) technology, the annotation 62 to be superimposed on the real scene. The annotation 62 is an image, a character string, or the like indicating an instruction for the operator. In the example illustrated in FIG. 4, an image of an arrow is used as the annotation 62.

In FIG. 4, a display region 64 for AR display is schematically illustrated. The display region 64 is a region formed on the display of the HMD as the operator apparatus 10. An image captured by the photographing device 14 of the operator apparatus 10 and the annotation 62 are displayed in the display region 64. The processor 24 displays the annotation 62 with the posture indicated by the posture information included in the instruction information at the position indicated by the positional information included in the instruction information. That is, the processor 24 displays the annotation 62 with the posture indicated by the posture information at the position with respect to the object 38, the position corresponding to the position at which the annotation 60 is provided with respect to the three-dimensional model 48. As described above, through the operator apparatus 10, the annotation 62 is displayed at the position corresponding to the position at which the annotation 60 is provided with respect to the three-dimensional model 48.

The supporter provides an instruction to the operator by observing on the screen 56 an image captured by the photographing device 14 of the operator apparatus 10 and providing on the screen 58 the annotation 60 with respect to the three-dimensional model 48 for the object 38.

When a specific operation is performed for the three-dimensional model 48 displayed on the screen 58, the processor 32 of the supporter apparatus 12 displays the three-dimensional model 48 on the screen 58 in such a manner that the orientation of the three-dimensional model 48 is fixed.

That is, when a specific operation is not performed for the three-dimensional model 48, the processor 32 of the supporter apparatus 12 changes the position and the posture of the virtual camera 54 following the position and the posture of the operator apparatus 10. As described above, the processor 32 changes the orientation of the three-dimensional model 48 following the position and the posture of the operator apparatus 10 and displays the three-dimensional model 48 on the screen 58. When a specific operation is performed for the three-dimensional model 48, the processor 32 displays the three-dimensional model 48 on the screen 58 in such a manner that the orientation of the three-dimensional model 48 is fixed, not following the position and the posture of the operator apparatus 10.

The specific operation is an operation that is presumed to be an action by the supporter to provide an instruction to the operator on the screen 58.

For example, a specific operation for the three-dimensional model 48 is an operation for enlarged display or reduced display of the three-dimensional model 48 displayed on the screen 58. When the supporter operates the UI 28 of the supporter apparatus 12 to provide an instruction for enlarged display (that is, zooming in) of the three-dimensional model 48, the processor 32 of the supporter apparatus 12 fixes the orientation of the three-dimensional model 48, enlarges the three-dimensional model 48, and displays the three-dimensional model 48 on the screen 58. When the supporter operates the UI 28 to provide an instruction for reduced display (that is, zooming out) of the three-dimensional model 48, the processor 32 fixes the orientation of the three-dimensional model 48, reduces the three-dimensional model 48, and displays the three-dimensional model 48 on the screen 58.

It is assumed that the supporter enlarges or reduces display of the three-dimensional model 48 when providing an instruction to the operator. In this case, by displaying the three-dimensional model 48 with the orientation of the three-dimensional model 48 fixed, the supporter is able to easily provide the annotation 60 with respect to the three-dimensional model 48, compared to the case where the orientation of the three-dimensional model 48 is not fixed but is changed following the motion of the operator apparatus 10. That is, compared to the case where the three-dimensional model 48 is directly displayed following the motion of the operator apparatus 10, the supporter is able to support easily.

As another example, the specific operation is an operation for providing the annotation 60 with respect to the three-dimensional model 48. In this case, by displaying the three-dimensional model 48 with the orientation of the three-dimensional model 48 fixed, the supporter is able to easily provide the annotation 60 with respect to the three-dimensional model 48, compared to the case where the orientation of the three-dimensional model 48 is changed following the motion of the operator apparatus 10. For example, an image of a button or the like for issuing an instruction for providing the annotation 60 is displayed on the screen 58 of the like. When the supporter presses the image of the button or the like, the processor 32 displays the three-dimensional model 48 on the screen 58 in such a manner that the orientation of the three-dimensional model 48 is fixed.

Furthermore, even when the operator apparatus 10 moves within a predetermined operation region, the processor 32 of the supporter apparatus 12 may display the three-dimensional model 48 on the screen 58 in such a manner that the orientation of the three-dimensional model 48 is fixed. For example, a plurality of operation regions are set in the field 34, and three-dimensional models 48 whose orientations are different are set in advance for the individual operation regions. The processor 32 displays the three-dimensional model 48 on the screen 58 in such a manner that the orientations of the three-dimensional models 48 are different among the operation regions in which the operator apparatus 10 is present.

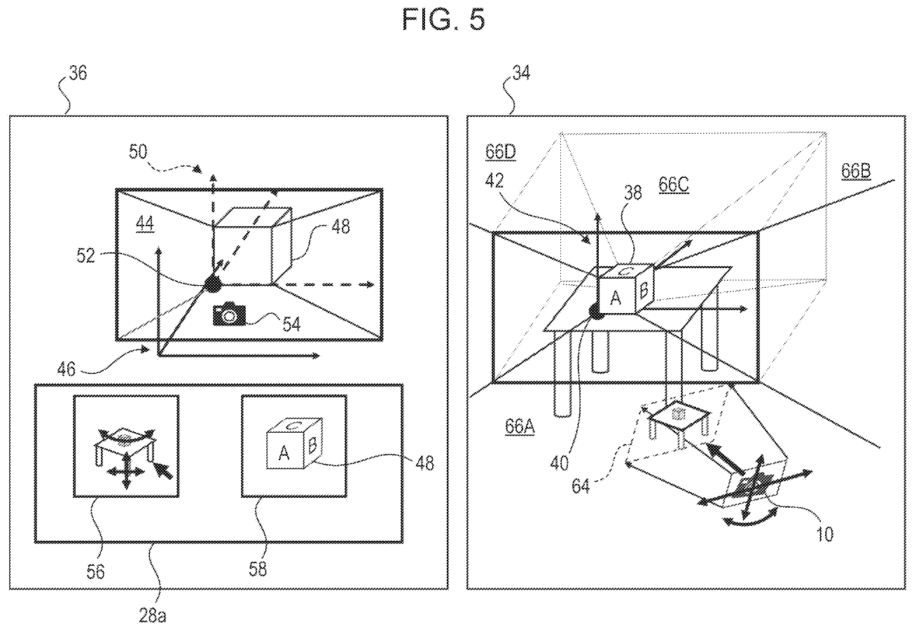

This example will be described below with reference to FIG. 5. FIG. 5 illustrates the field 34 and the remote location 36, as in FIG. 4.

For example, in the field 34, a plurality of operation regions are set based on the object 38. For convenience of description, the object 38 is assumed to be a cube. A region to which a face A of the object 38 is oriented in the real space of the field 34 is set as an operation region 66A. A region to which a face B of the object 38 is oriented is set as an operation region 66B. A region to which a face C of the object 38 is oriented is set as an operation region 66C. A region to which a face opposite the face B is oriented is set as an operation region 66D. A region to which a face opposite the face A is oriented is set as an operation region 66E. Positional information indicating the individual operation regions is stored in advance in the memory 30 of the supporter apparatus 12.

The three-dimensional model 48 is a cube, as with the object 38. A face A of the three-dimensional model 48 corresponds to the face A of the object 38, a face B of the three-dimensional model 48 corresponds to the face B of the object 38, and a face C of the three-dimensional model 48 corresponds to the face C of the object 38. The same applies to the other faces.

For example, in the case where the operator apparatus 10 is present in the operation region 66A (that is, in the case where the position indicated by the positional information of the operator apparatus 10 is included in the operation region 66A), the processor 32 of the supporter apparatus 12 sets the orientation of the three-dimensional model 48 in such a manner that the face A of the three-dimensional model 48 is displayed on the screen 58 and displays the three-dimensional model 48 on the screen 58. For example, a position A is set within the operation region 66A, and positional information indicating the position A is stored in advance in the memory 30 of the supporter apparatus 12. The processor 32 displays on the screen 58 the three-dimensional model 48 seen from the position A. The position A is a position fixed in the operation region 66A. Even if the operator apparatus 10 moves within the operation region 66A, the processor 32 displays the three-dimensional model 48 on the screen 58 in such a manner that the position A with respect to the three-dimensional model 48 is fixed and the face A of the three-dimensional model 48 is displayed on the screen 58. That is, even if the operator apparatus 10 moves within the operation region 66A, display of the three-dimensional model 48 is not changed, and the three-dimensional model 48 is displayed on the screen 58 in such a manner that the orientation of the three-dimensional model 48 is fixed.

In the case where the operator apparatus 10 is present in the operation region 66B (that is, in the case where the position indicated by the positional information of the operator apparatus 10 is included in the operation region 66B), the processor 32 of the supporter apparatus 12 sets the orientation of the three-dimensional model 48 in such a manner that the face B of the three-dimensional model 48 is displayed on the screen 58 and displays the three-dimensional model 48 on the screen 58. For example, a position B is set within the operation region 66B, and positional information indicating the position B is stored in advance in the memory 30 of the supporter apparatus 12. The processor 32 displays on the screen 58 the three-dimensional model 48 seen from the position B. The position B is a position fixed in the operation region 66B. Even if the operator apparatus 10 moves within the operation region 66B, the processor 32 displays the three-dimensional model 48 on the screen 58 in such a manner that the position B and the orientation of the three-dimensional model 48 are fixed and the face B of the three-dimensional model 48 is displayed on the screen 58.

The same applies to the cases where the operator apparatus 10 are present in the operation regions 66C, 66D, and 66E.

For example, in the case where the operator apparatus 10 is present in the operation region 66A, the processor 32 fixes the position A and the orientation of the three-dimensional model 48 so that the face A of the three-dimensional model 48 is displayed on the screen 58 and displays the three-dimensional model 48 on the screen 58. When the operator apparatus 10 moves from the operation region 66A to the operation region 66B, the processor 32 changes the position from the position A to the position B and fixes the position B and the orientation of the three-dimensional model 48 so that the face B of the three-dimensional model 48 is displayed on the screen 58 and displays the three-dimensional model 48 on the screen 58. The same applies to the case where the operator apparatus 10 moves to another operation region. As described above, display of the three-dimensional model 48 discontinuously changes in accordance with moving of the operator apparatus 10.

As described above, even if the operator apparatus 10 moves within an operation region, the three-dimensional model 48 is displayed on the screen 58 in such a manner that the position and the orientation of the three-dimensional model 48 are fixed. Thus, compared to the case where the position and the orientation of the three-dimensional model 48 changes following the motion of the operator apparatus 10, the supporter is able to easily provide the annotation 60 with respect to the three-dimensional model 48.

The shape and size of each operation region may be set in advance according to the shape, size, type, and the like of the object 38 or may be set by the operator or the supporter. The number of operation regions may be set in advance according to the shape, size, type, and the like of the object 38 or may be set by the operator or the supporter.

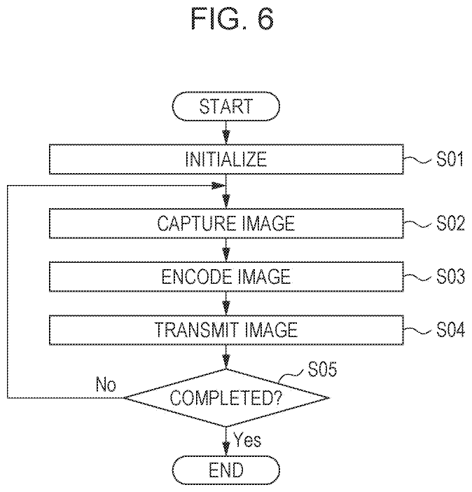

Processes according to this exemplary embodiment will be described below with reference to FIGS. 6 to 10.

The flow of a process performed by the operator apparatus 10 will be described with reference to FIG. 6. FIG. 6 is a flowchart illustrating the flow of the process performed by the operator apparatus 10.

The operator apparatus 10 is initialized (S01), and an image (for example, a moving image or a still image) is captured by the photographing device 14 of the operator apparatus 10 (S02). The processor 24 of the operator apparatus 10 encodes the captured image (S03) and transmits the encoded image to the supporter apparatus 12 (S04). In the case where an operation, photographing, or the like in the field 34 is not completed (in S05, No), the process proceeds to step S02. In the case where an operation, photographing, or the like is completed (in S05, Yes), the process of the operator apparatus 10 ends.

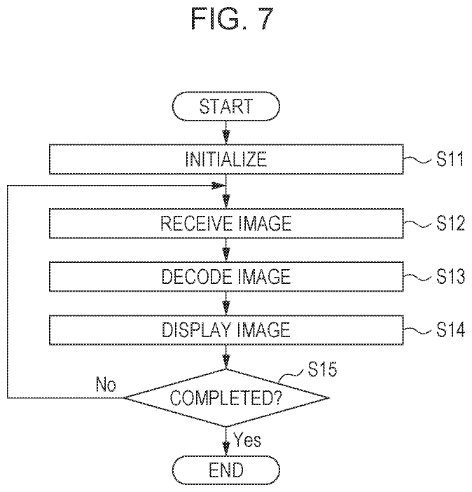

The flow of a process performed by the supporter apparatus 12 will be described with reference to FIG. 7. FIG. 7 is a flowchart illustrating the flow of the process performed by the supporter apparatus 12.

The supporter apparatus 12 is initialized (S11), and the supporter apparatus 12 receives the image transmitted from the operator apparatus 10 (S12). The processor 32 of the supporter apparatus 12 decodes the encoded image (S13) and displays the decoded image on the display of the UI 28 (S14). In the case where an operation, photographing, or the like in the field 34 is not completed (in S15, No), the process proceeds to step S12. In the case where an operation, photographing, or the like is completed (in S15, Yes), the process of the supporter apparatus 12 ends.

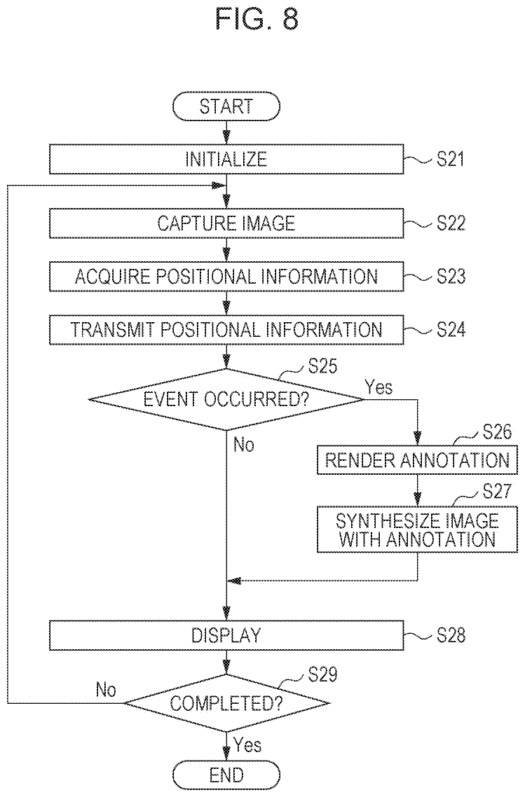

A process for implementing AR display on the operator apparatus 10 will be described with reference to FIG. 8. FIG. 8 is a flowchart illustrating the flow of a process performed by the operator apparatus 10.

The operator apparatus 10 is initialized (S21), and an image (for example, a moving image or a still image) is captured by the photographing device 14 of the operator apparatus 10 (S22). The positional information acquisition unit 18 of the operator apparatus 10 acquires positional information and posture information of the operator apparatus 10 (S23). The positional information and the posture information are transmitted to the supporter apparatus 12 (S24). When an event such as provision of an annotation occurs in the supporter apparatus 12 (in S25, Yes), the processor 24 of the operator apparatus 10 renders the annotation using augmented reality (AR) on the basis of the field of view of the operator (that is, the position of the HMD as the operator apparatus 10) (S26), and synthesizes the image captured by the photographing device 14 with the annotation (S27). The processor 24 displays the synthesized annotation and image (S28). When no event such as provision of an annotation occurs in the supporter apparatus 12 (in S25, No), the processor 24 displays the image captured by the photographing device 14 (S28). In the case where an operation, photographing, or the like is not completed (in S29, No), the process proceeds to step S22. In the case where an operation, photographing, or the like is completed (in S29, Yes), the process of the operator apparatus 10 ends.

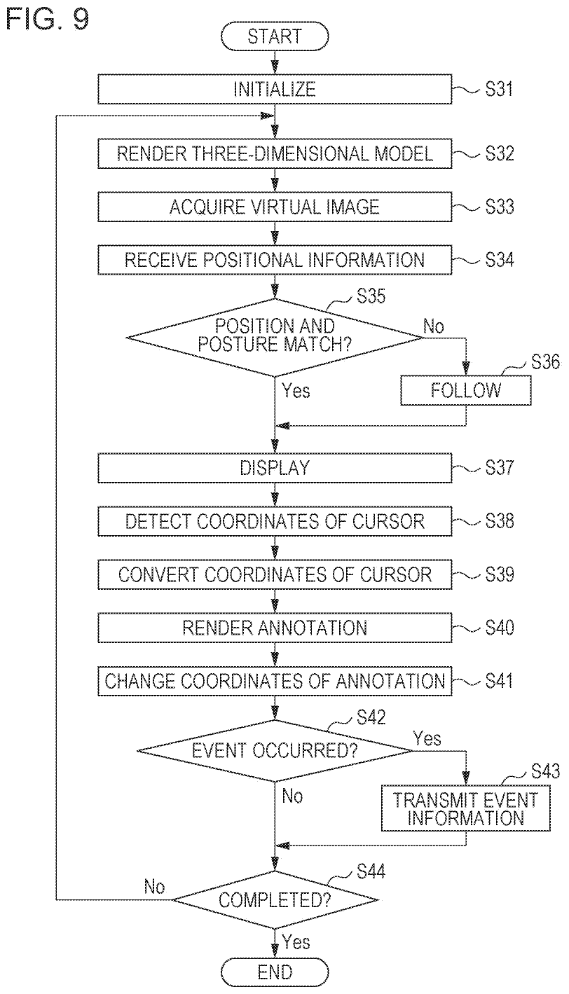

A process for displaying the three-dimensional model 48 following the motion of the operator apparatus 10 will be described with reference to FIG. 9. FIG. 9 is a flowchart illustrating the flow of this process.

The supporter apparatus 12 is initialized (S31), and the processor 32 of the supporter apparatus 12 renders the three-dimensional model 48 for the object 38 in the three-dimensional virtual space 44 (S32). The processor 32 acquires an image of the three-dimensional model 48 (that is, a virtual image) by capturing the three-dimensional model 48 with the virtual camera 54 representing the operator apparatus 10 in the three-dimensional virtual space 44 (S33). This image is an image representing the shape of the three-dimensional model 48 when the three-dimensional model 48 is seen from the virtual camera 54 in the three-dimensional virtual space 44.

The positional information and the posture information of the operator apparatus 10 are transmitted from the operator apparatus 10 to the supporter apparatus 12, and the processor 32 of the supporter apparatus 12 receives the positional information and the posture information of the operator apparatus 10 (S34). The processor 32 determines whether or not the position of the virtual camera 54 in the three-dimensional virtual space 44 matches the position indicated by the positional information (S35). The processor 32 also determines whether or not the posture of the virtual camera 54 in the three-dimensional virtual space 44 matches the posture indicated by the posture information (S35). That is, the processor 32 determines whether or not the position and the posture of the virtual camera 54 in the three-dimensional virtual space 44 match the position and the posture of the operator apparatus 10 in the real space. In the case where the position and the posture of the virtual camera 54 in the three-dimensional virtual space 44 do not match the position and the posture of the operator apparatus 10 in the real space (in S35, No), the processor 32 places the virtual camera 54 at the position indicated by the positional information in the three-dimensional virtual space 44 and makes the posture of the virtual camera 54 match the posture indicated by the positional information (S36). Thus, the position and the posture of the virtual camera 54 follow the motion of the operator apparatus 10 in the real space. Then, the processor 32 displays the three-dimensional model 48 on the screen 58 (S37). In the case where the position and the posture of the virtual camera 54 in the three-dimensional virtual space 44 match the position and the posture of the operator apparatus 10 in the real space (in S35, Yes), the processor 32 displays the three-dimensional model 48 on the screen 58 (S37).

In the case where the supporter wants to provide an annotation using a cursor such as a mouse cursor, the cursor is displayed on the screen 58. The processor 32 of the supporter apparatus 12 detects coordinates of the cursor on the screen 58 (S38), and converts the detected coordinates into coordinates in the three-dimensional virtual space 44 (S39). Conversion of coordinates is performed according to predetermined conditions.

When the supporter issues an instruction for providing an annotation, the processor 32 of the supporter apparatus 12 renders the annotation 60 (S40). When the supporter changes the position of the annotation 60, coordinates of the annotation 60 in the three-dimensional virtual space 44 are changed (S41).

When an event (for example, provision of the annotation 60) for supporting the operator occurs in the supporter apparatus 12 (in S42, Yes), information indicating the event is transmitted from the supporter apparatus 12 to the operator apparatus 10 (S43). Then, the process proceeds to step S44.

In the case where there is no event for supporting the operator in the supporter apparatus 12 (in S42, No), the process proceeds to step S44.

In the case where an operation, photographing, or the like in the field 34 is not completed (in S44, No), the process proceeds to step S32. In the case where an operation, photographing, or the like is completed (in S44, Yes), the process of the supporter apparatus 12 ends.

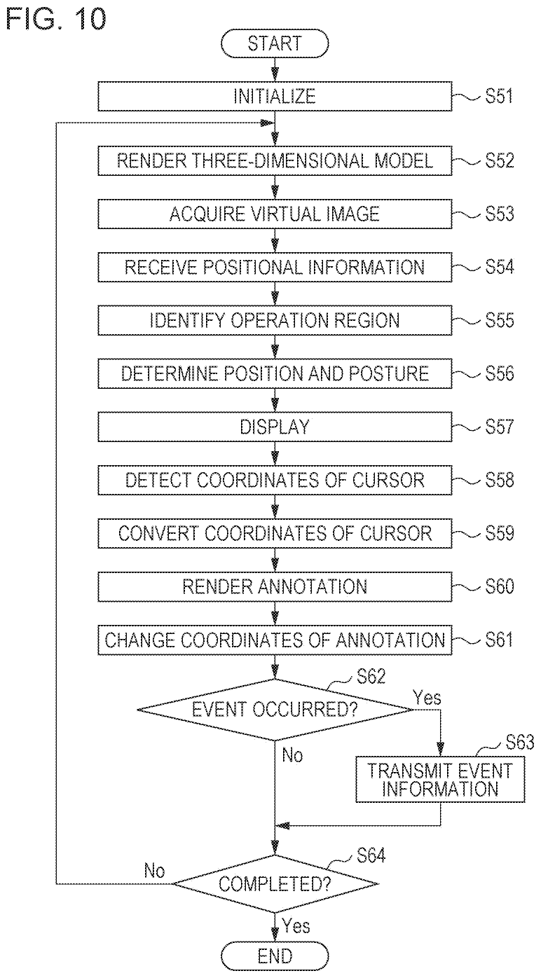

A process for fixing display of the three-dimensional model 48 will be described with reference to FIG. 10. FIG. 10 is a flowchart illustrating the flow of this process.

The supporter apparatus 12 is initialized (S51), and the processor 32 of the supporter apparatus 12 renders the three-dimensional model 48 for the object 38 in the three-dimensional virtual space 44 (S52). The processor 32 acquires an image of the three-dimensional model 48 (that is, a virtual image) by photographing, with the virtual camera 54 representing the operator apparatus 10, the three-dimensional model 48 in the three-dimensional virtual space 44 (S53). This image is an image representing the shape of the three-dimensional model 48 when the three-dimensional model 48 is seen from the virtual camera 54 in the three-dimensional virtual space 44.

The positional information and the posture information of the operator apparatus 10 are transmitted from the operator apparatus 10 to the supporter apparatus 12, and the processor 32 of the supporter apparatus 12 receives the positional information and the posture information of the operator apparatus 10 (S54). The processor 32 identifies, based on the position indicated by the positional information, an operation region in which the operator apparatus 10 is present in the real space (S55). The processor 32 determines the position and the posture of the virtual camera 54 corresponding to the identified operation region (S56). For example, in the case where the operator apparatus 10 is present in the operation region 66A, the processor 32 determines the position and the posture of the virtual camera 54 corresponding to the operation region 66A. The processor 32 arranges the virtual camera 54 with the determined posture at the determined position in the three-dimensional virtual space 44, and displays on the screen 58 the three-dimensional model 48 seen from the virtual camera 54 (S57).

In the case where the supporter wants to provide an annotation using a cursor such as a mouse cursor, the cursor is displayed on the screen 58. The processor 32 of the supporter apparatus 12 detects coordinates of the cursor on the screen 58 (S58), and converts the detected coordinates into coordinates in the three-dimensional virtual space 44 (S59). Conversion of coordinates is performed according to predetermined conditions.

When the supporter issues an instruction for providing an annotation, the processor 32 of the supporter apparatus 12 renders the annotation 60 (S60). When the supporter changes the position of the annotation 60, coordinates of the annotation 60 in the three-dimensional virtual space 44 are changed (S61).

When an event (for example, provision of the annotation 60) for supporting the operator occurs in the supporter apparatus 12 (in S62, Yes), information indicating the event is transmitted from the supporter apparatus 12 to the operator apparatus 10 (S63). Then, the process proceeds to step S64.

In the case where there is no event for supporting the operator in the supporter apparatus 12 (in S62, No), the process proceeds to step S44.

In the case where an operation, photographing, or the like in the field 34 is not completed (in S64, No), the process proceeds to step S52. In the case where an operation, photographing, or the like is completed (in S64, Yes), the process of the supporter apparatus 12 ends.

The functions of the operator apparatus 10 and the supporter apparatus 12 are implemented by, for example, cooperation between hardware and software. For example, the functions of the operator apparatus 10 are implemented when the processor 24 of the operator apparatus 10 reads and executes a program stored in the memory. The program is stored in the memory via a recording medium such as a compact disc (CD) or a digital versatile disc (DVD) or via a communication path such as a network. Similarly, the functions of the supporter apparatus 12 are implemented when the processor 32 of the supporter apparatus 12 reads and executes a program stored in the memory. The program is stored in the memory via a recording medium such as a CD or a DVD or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
display a three-dimensional model representing an object, following a position of an information processing apparatus that photographs the object, on a display for a supporter who supports an operation by an operator who uses the information processing apparatus; and
when a specific operation is performed for the three-dimensional model displayed on the display, display the three-dimensional model on the display in such a manner that an orientation of the three-dimensional model is fixed.
   (((2)))

The information processing system according to (((1))), wherein the specific operation is an operation for enlarged display or reduced display of the three-dimensional model.

(((3)))

The information processing system according to (((1))),
wherein the specific operation is an operation for providing an annotation to the three-dimensional model displayed on the display, and
wherein in a case where the annotation is provided to the three-dimensional model, the annotation is displayed, via the information processing apparatus, at a position with respect to the object, the position corresponding to a position at which the annotation is provided with respect to the three-dimensional model.
   (((4)))

The information processing system according to any one of (((1))) to (((3))), wherein the processor is configured to, even when the information processing apparatus moves within a predetermined operation region, display the three-dimensional model on the display in such a manner that an orientation of the three-dimensional model is fixed.

(((5)))

The information processing system according to (((4))),
wherein three-dimensional models with different orientations are set for individual operation regions, and
wherein the processor is configured to display the three-dimensional models on the display in such a manner that orientations of the three-dimensional models are different among the operation regions in which the information processing apparatus is present.
   (((6)))

A program for causing a computer to execute a process comprising:
displaying a three-dimensional model representing an object, following a position of an information processing apparatus that photographs the object, on a display for a supporter who supports an operation by an operator who uses the information processing apparatus; and
when a specific operation is performed for the three-dimensional model displayed on the display, displaying the three-dimensional model on the display in such a manner that an orientation of the three-dimensional model is fixed.

What is claimed is:

1. An information processing system comprising:
a processor configured to:
display a three-dimensional model representing an object, following a position of an information processing apparatus that photographs the object, on a display for a supporter who supports an operation by an operator who uses the information processing apparatus; and
when a specific operation is performed for the three-dimensional model displayed on the display, display the three-dimensional model on the display in such a manner that an orientation of the three-dimensional model is fixed.

2. The information processing system according to claim 1, wherein the specific operation is an operation for enlarged display or reduced display of the three-dimensional model.

3. The information processing system according to claim 1,
wherein the specific operation is an operation for providing an annotation to the three-dimensional model displayed on the display, and
wherein in a case where the annotation is provided to the three-dimensional model, the annotation is displayed, via the information processing apparatus, at a position with respect to the object, the position corresponding to a position at which the annotation is provided with respect to the three-dimensional model.

4. The information processing system according to claim 1, wherein the processor is configured to, even when the information processing apparatus moves within a predetermined operation region, display the three-dimensional model on the display in such a manner that an orientation of the three-dimensional model is fixed.

5. The information processing system according to claim 2, wherein the processor is configured to, even when the information processing apparatus moves within a predetermined operation region, display the three-dimensional model on the display in such a manner that an orientation of the three-dimensional model is fixed.

6. The information processing system according to claim 3, wherein the processor is configured to, even when the information processing apparatus moves within a predetermined operation region, display the three-dimensional model on the display in such a manner that an orientation of the three-dimensional model is fixed.

7. The information processing system according to claim 4,
wherein three-dimensional models with different orientations are set for individual operation regions, and
wherein the processor is configured to display the three-dimensional models on the display in such a manner that orientations of the three-dimensional models are different among the operation regions in which the information processing apparatus is present.

8. The information processing system according to claim 5,
wherein three-dimensional models with different orientations are set for individual operation regions, and
wherein the processor is configured to display the three-dimensional models on the display in such a manner that orientations of the three-dimensional models are different among the operation regions in which the information processing apparatus is present.

9. The information processing system according to claim 6,
wherein three-dimensional models with different orientations are set for individual operation regions, and
wherein the processor is configured to display the three-dimensional models on the display in such a manner that orientations of the three-dimensional models are different among the operation regions in which the information processing apparatus is present.

10. A non-transitory computer readable medium storing a program causing a computer to execute a process comprising:
displaying a three-dimensional model representing an object, following a position of an information processing apparatus that photographs the object, on a display for a supporter who supports an operation by an operator who uses the information processing apparatus; and
when a specific operation is performed for the three-dimensional model displayed on the display, displaying the three-dimensional model on the display in such a manner that an orientation of the three-dimensional model is fixed.

11. An information processing method comprising:
displaying a three-dimensional model representing an object, following a position of an information processing apparatus that photographs the object, on a display for a supporter who supports an operation by an operator who uses the information processing apparatus; and
when a specific operation is performed for the three-dimensional model displayed on the display, displaying the three-dimensional model on the display in such a manner that an orientation of the three-dimensional model is fixed.
